(19) United States
(12) Patent Application Publication
(10) Pub. No.: US 2011/0128533 A1
(43) Pub. Date: Jun. 2, 2011

(54) SURFACE-CHECK EQUIPMENT

(76) Inventor: Hui-Hsiung LEE, Taipei (TW)

(21) Appl. No.: 12/628,399

(22) Filed: Dec. 1, 2009

(51) Int. Cl. G01N 21/88

(52) U.S. Cl. 356/237.2

(57) ABSTRACT

A surface-check equipment has a frame, at least one lamp fastened to the frame and at least one dark box fastened to the frame. The dark box has a case with a working side and a dark chamber. The working side has a slot defined through the working side and allowing light to enter the dark box via the slot. The dark chamber communicates with the slot and has an incident reflector, at least one transmitting reflector, a refractor assembly, at least one terminal reflector, and a sensor corresponding to each other and allowing light from the object via the slot to be reflected and refracted and received by the sensor. Therefore, the dark box has simple and inexpensive elements, so the surface-check equipment is easily and quickly assembled and has decreased cost and size.

### BACKGROUND OF THE INVENTION

1. Field of Invention

The present invention relates to a surface-check equipment, and more particularly to a surface-check equipment with reduced size and quick checking of an object.

2. Description of the Related Art

Generally, a quality of an object can be determined by a surface-check equipment. A conventional surface-check equipment comprises at least one conveyer, at least two line charge-coupled device (CCD) cameras, at least two lamps and a digital controller. The conveyer carries an object. The lamps correspond respectively to the cameras. The conveyer conveys the object and the lamps respectively face and emit light to upper and lower surfaces of the object. The upper and lower surfaces respectively reflect the light. The cameras respectively capture reflected light from the upper and lower surfaces to generate signals. The signals transfer to the digital controller for analyzing the signals. Therefore, the quality of the object can be determined.

With reference to FIG. 4, a CCD camera (60) has a photo-sensitive element (61), an extension tube (62) and camera lens assembly (63). The camera lens assembly (63) and the photo-sensitive element (61) are respectively installed on the ends of the extension tube (62). The camera lens assembly (63) has an aperture (631), a focus module (632) and multiple lenses (633) including concave and convex lenses. The camera lens (63) captures light reflected from an object to form an image in the photo-sensitive element (61). The image is transmitted to a digital controller (71, such as a filed-programmable gate array (FPGA), in a computer (70) to analyze the image.

However, a specific distance has to be maintained between the camera (60) and the object (50), so the conventional surface-check equipment has large size. Furthermore, the aperture (631) and focus module (632) are required to be manually adjusted during examination, so the examination is postponed for adjustment between different thickness objects (50). Additionally, the CCD camera (60) is very expensive, so price savings of the conventional surface-check equipment are limited by camera expense.

To overcome the shortcomings, the present invention provides a surface-check equipment to mitigate or obviate the aforementioned.

### SUMMARY OF THE INVENTION

The primary objective of the present invention is to provide a surface-check equipment with reduced size and quick checking of an object.

To achieve the objective, the surface-check equipment in accordance with the present invention comprises a frame, at least one lamp and at least one dark box fastened to the frame. The lamp is fastened to the frame. The dark box is fastened to the frame and has a case with a working side and a dark chamber. The working side has a slot defined through the working side and allowing light to enter the dark box via the slot. The dark chamber communicates with the slot and has an incident reflector, at least one transmitting reflector, a refractor assembly, at least one terminal reflector, and a sensor corresponding to each other and allowing light from the object via the slot to be reflected and refracted and received by the sensor.

Therefore, the dark box has simple and inexpensive elements, so the surface-check equipment is easily and quickly assembled and has decreased cost and size.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a surface-check equipment in accordance with the present invention;

FIG. 2 is a perspective view of a dark box of the surface-check equipment in FIG. 1;

FIG. 3 is a diagram of a dark box showing light emitted from a lamp, reflected by the object and travelling in the dark box; and

FIG. 4 is block-diagram of a CCD camera connected with a computer with a digital controller in accordance with the prior art.

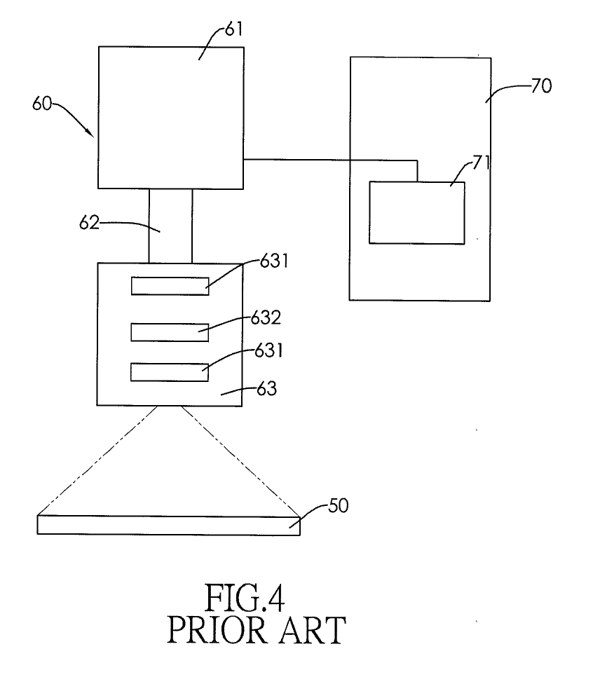

### DETAILED DESCRIPTION OF THE INVENTION

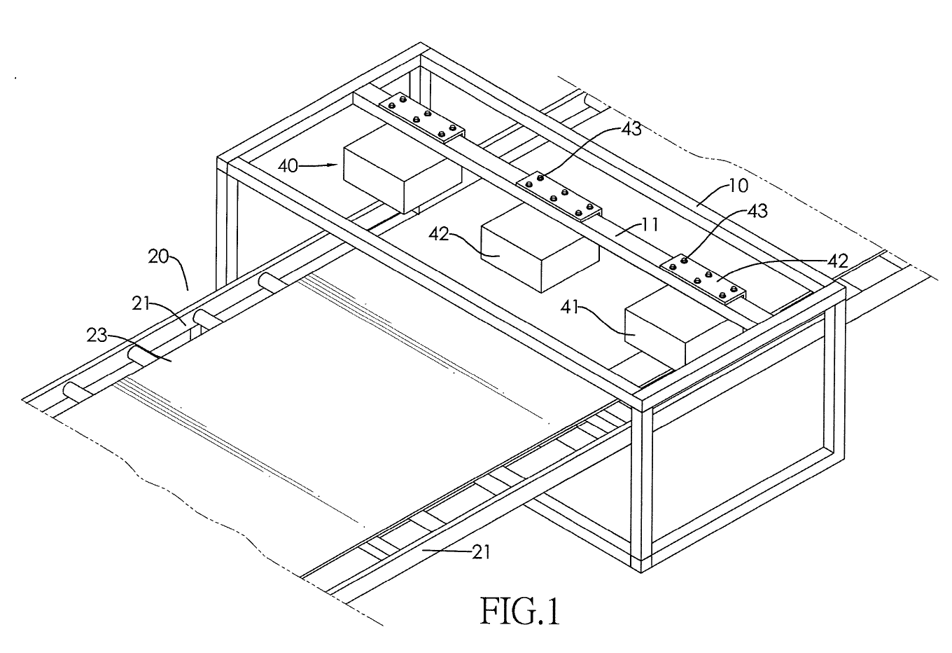

With reference to FIG. 1, a surface-check equipment in accordance with the present invention is used to check surfaces of an object (50), such as a substrate, cloth or the like. The surface-check equipment has a frame (10), a conveyer (20), at least one lamp (30) and at least one dark box (40).

The frame (10) is rectangular and has a top, a bottom, two ends and at least one fastening rod (11). The fastening rod (11) connects the ends of the frame (10) and has multiple threaded holes.

The conveyer (20) is mounted through the frame (10) from one end to the other and conveys the object (50) through the frame (10). The conveyer (20) has two holding rods (21), multiple rollers (22) and a conveyer belt (23). The holding rods (21) are fastened to the frame (10) and are parallel with the fastening rod (11). The rollers (22) are separately disposed along the conveyor (20) and each roller (22) connects the holding rods (21) and is mounted between the holding rods (21). The conveyer belt (23) carries the object (50), abuts the rollers (22) and may be pervious to light.

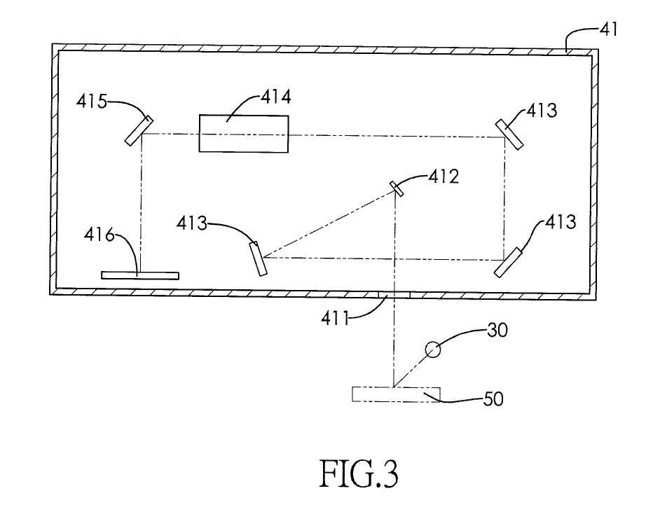

With further reference to FIG. 3, each lamp (30) is fastened to the frame (10), faces the conveyer (20) and is mounted respectively above the upper surface of the conveyer (20) and/or below the lower surface of the conveyer (20) to respectively shine light onto an upper and lower surface of the object (50).

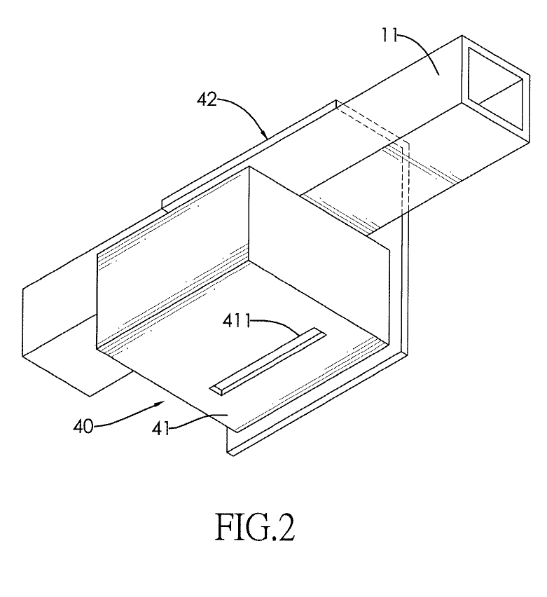

With further reference to FIG. 2, the dark box (40) is fastened to the fastening rod (11) of the frame (10) and has a case (41) and a fastening sheet (42).

The case (41) has a working side and a dark chamber. The working side faces the conveyer (20) and has a slot (411). The slot (411) is defined through the working side to allow light to be reflected from the object (50) into the dark box (40) via the slot (411). The dark chamber communicates with the slot (411) and has an incident reflector (412), at least one transmitting reflector (413), a refractor assembly (414), at least one terminal reflector (415) and a sensor (416).

The incident reflector (412) corresponds to the slot (411) and is located at a position that receives and then reflects the light reflected from the object (50) and passes the slot (411).

The transmitting reflector (413) corresponds to the incident reflector (412) and is located at a position that receives and then reflects the light reflected from the incident reflector (412).

The refractor assembly (414) corresponds to the transmitting reflector (413), is located at a position that receives and then refracts the light reflected from the transmitting reflector (413) and has as at least one convex lens or at least one concave lens or a combination thereof.

The terminal reflector (415) corresponds to the refractor assembly (414) and is located at a position that receives and then reflects the light refracted from the refractor assembly (414).

The sensor (416) corresponds to the terminal reflector (415) and is located at a position that receives the light reflected from the terminal reflector (415). The sensor (416) electrically connects at least one port on the case (41) for further connecting to a computer by wires.

The fastening sheet (42) is L-shaped, protrudes from the case (41) and has multiple fastening holes allowing screws (43) to respectively extend into the fastening holes of the fastening sheet (42) and to screw with the threaded holes of the fastening rod (11), so the dark box (40) is fastened to the fastening rod (11).

The number of the transmitting reflector (413) and terminal reflector (415) can be varied as desired. The slot (411), the incident reflector (412), the transmitting reflector (413), the refractor assembly (414), the terminal reflector (415) and the sensor (416) correspond to each other, so the incident reflector (412), the transmitting reflector (413), the refractor assembly (414), the terminal reflector (415) and the sensor (416) have no fixed position as long as the light reflected from the object (50) is able to reach the sensor (416) via the incident reflector (412), the transmitting reflector (413), the refractor assembly (414) and the terminal reflector (415).

When the surface-check equipment of the present invention is used, a lamp emits light toward the object (50) and the object (50) reflects the light. The incident reflector (412) receives the light from the object (50) through the slot (411) and then reflects the light to the transmitting reflector (413). The transmitting reflector (413) receives the light from the incident reflector (412) and then reflects the light to the refractor assembly (414). The refractor assembly (414) receives the light from the transmitting reflector (413) and then refracts the light to the terminal reflector (415). The terminal reflector (415) receives the light from the refractor assembly (414) and then reflects it to the sensor (416). The sensor receives the light form the terminal reflector (415) and generates image signals. The image signals is transmitted to the computer for analyzing the image signals to determine the quality of the object (50).

Therefore, the dark box (40) has simple and inexpensive elements and the surface-check equipment of the present invention is easily and quickly assembled and has decreased cost. Further, manual adjustment of the aperture and focus module is not required during examination so the surface-check equipment of the present invention rapidly checks an object (50). Also, a distance between the dark box (40) and the object (50) can be reduced, therefore, the surface-check equipment of the present invention has reduced size.

Even though numerous characteristics and advantages of the present invention have been set forth in the foregoing description, together with details of the structure and function of the invention, the disclosure is illustrative only. Changes may be made in detail, especially in matters of shape, size and arrangement of parts within the principles of the invention to the full extent indicated by the broad general meaning of the terms in which the appended claims are expressed.

What is claimed is:

1. A surface-check equipment comprising:
a frame;
at least one lamp fastened to the frame; and
at least one dark box fastened to the frame and having a case having
a working side having a slot defined through the working side and allowing light to enter the dark box via the slot; and
a dark chamber communicating with the slot and having
an incident reflector corresponding to the slot of the working side and located at a position that receives and then reflects the light reflected from the object and passed the slot;
at least one transmitting reflector corresponding to the incident reflector and located at a position that receives and then reflects the light reflected from the incident reflector;
a refractor assembly corresponding to the transmitting reflector, located at a position that receives and then refracts the light reflected from the transmitting reflector;
at least one terminal reflector corresponding to the refractor assembly and located at a position that receives and then reflects the light refracted from the refractor assembly; and
a sensor corresponding to the terminal reflector and located at a position that receives the light reflected from the terminal reflector.

2. The surface-check equipment as claimed in claim 1, further having a conveyer fastened to the frame; wherein
the lamp faces the conveyer; and
the working side faces the conveyer.
